(19) United States
(12) Patent Application Publication
(10) Pub. No.: US 2022/0318699 A1
(43) Pub. Date: Oct. 6, 2022

(54) EVALUATION APPARATUS, EVALUATION METHOD AND PROGRAM

(71) Applicant: Nippon Telegraph and Telephone Corporation, Tokyo (JP)

(72) Inventors: Machiko Shinozuka, Musashino-shi, Tokyo (JP); Hiroki Oka, Musashino-shi, Tokyo (JP); Takashi Furutani, Musashino-shi, Tokyo (JP); Xiaoxi Zhang, Musashino-shi, Tokyo (JP); Katsuya Hayashi, Musashino-shi, Tokyo (JP)

(21) Appl. No.: 17/616,868

(22) PCT Filed: Jun. 18, 2019
(86) PCT No.: PCT/JP2019/024148

§ 371 Date: Dec. 6, 2021

(51) Int. Cl. G06Q 10/06

(52) U.S. Cl. CPC G06Q 10/0635; G06Q 50/06

(57) ABSTRACT

Provided is an assessment device that includes: an input unit that receives, as an input, a use field of an ICT solution as an assessment target and a damage item as a target of the ICT solution; a risk extraction unit that extracts one or more risk candidates corresponding to the use field and the damage item from a database in which use fields, damage items, and risks are associated; a calculation unit that calculates cooccurrence probability between each of the one or more risk candidates and an operation target of the ICT solution; and an output unit that outputs the risk candidates based on the cooccurrence probability.

### TECHNICAL FIELD

The present invention relates to an environmental impact assessment technique and, more specifically, to a technique for assisting to determine whether or not an ICT (Information and Communication Technology) solution contributes to climate change adaptation.

### BACKGROUND ART

As the climate change is becoming more serious, there is a demand for not only mitigation measures for suppressing the climate change but also adaptation measures for reducing the risk by dealing with the impact of the climate change. Further, there are a large number of companies that consider adaptation for the climate change as a business opportunity and conduct an adaptation business for setting up products and services that promote adaptation measures of other companies.

With the ICT solution, it is possible to detect the risk of having a flood caused due to overflowing through monitoring rivers, for example, and give an evacuation advisory to the residents. Such an ICT solution is expected to contribute to climate change adaptation (Non-Patent Literature 1, for example).

However, it is difficult for those who are not the experts having the knowledge regarding adaptation for the climate change and the effect and environmental impact of the ICT solution to determine which ICT solution with what kind of characteristic may possibly contribute to climate change adaptation. Specifically, it is difficult to determine the ICT solution that can reduce what kind of risk may possibly be adapted to the climate change. This is the obstacle for a company to appeal contribution of the own ICT solution for climate change adaptation.

In regards to the aforementioned problem, to be used for determining the solutions for social and economic problems, some prior art techniques perform modeling of the causal relationships of the phenomena related to such problems. However, such a prior art technique requires labor for determining and building the causal relationships of a large number of phenomena over many stages, so that expertise regarding climate change is required in order to model and analyze the phenomena and the risks related to the climate change. Therefore, with the prior art technique, it is difficult for those who are not the experts to determine the risk that can be reduced by using the ICT solution as the assessment target.

### CITATION LIST

### Non-Patent Literature

Non-Patent Literature 1: Ministry of Land, Infrastructure, Transport and Tourism, Climate Change Adaptation Seminar, “Challenges for Adaptation Using ICT”, http://www.mlit.go.jp/common/001170921.pdf

### SUMMARY OF THE INVENTION

### Technical Problem

An object of the present invention, which has been made in view of the foregoing aspects, is to provide a technique capable of easily determining the risk that may possibly be reduced by an ICT solution, which is an assessment target.

### Means for Solving the Problem

According to the technique of the disclosure, provided is an assessment device including: an input unit that receives, as an input, a use field of an ICT solution as an assessment target and a damage item as a target of the ICT solution; a risk extraction unit that extracts one or more risk candidates corresponding to the use field and the damage item from a database in which use fields, damage items, and risks are associated; a calculation unit that calculates cooccurrence probability between each of the one or more risk candidates and an operation target of the ICT solution; and an output unit that outputs the risk candidates based on the cooccurrence probability.

### Effects of the Invention

According to the technique of the disclosure, it is possible to provide such a technique capable of easily determining the risk that may possibly be reduced by the ICT solution as the assessment target.

### BRIEF DESCRIPTION OF DRAWINGS

FIG. 1 is a diagram illustrating a configuration example of an assessment device according to an embodiment of the present invention.

FIG. 2 is a diagram illustrating a hardware configuration example of the assessment device.

FIG. 3 is a flowchart illustrating a processing procedure of the assessment device.

FIG. 4 is a chart illustrating examples of use fields and detailed use fields.

FIG. 5 is a chart illustrating examples of damage items.

FIG. 6 is a chart illustrating examples of information stored in a causal relationship DB.

### DESCRIPTION OF EMBODIMENT

Hereinafter, an embodiment (the embodiment) of the present invention will be described with reference to the accompanying drawings. The embodiment described hereinafter is illustrative only, and the embodiment to which the present invention is applied is not limited to the following embodiment.

Hereinafter, as an example, described is a technique that allows even those who do not have the expert knowledge regarding the role of ICT solutions in climate change adaptation and climate change measures to easily recognize the climate change risk that can be reduced by the ICT solutions, and assists to determine whether or not the ICT solutions contribute to climate change adaptation.

(Device Configuration Example)

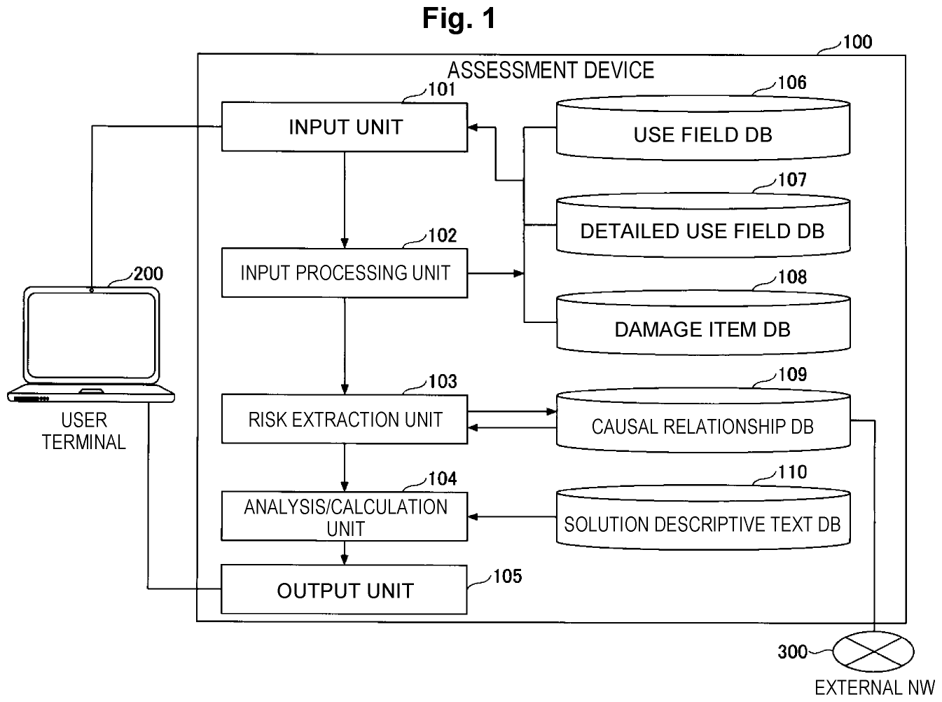

FIG. 1 is a functional block diagram of an assessment device 100 according to the embodiment. The assessment device 100 is a device that determines, from a use scene of the ICT solution as an assessment target, the risk that can be reduced because of the contribution of the ICT solution to climate change adaptation.

As illustrated in FIG. 1, the assessment device 100 includes: an input unit 101; an input processing unit 102; a risk extraction unit 103; an analysis/calculation unit 104; an output unit 105; a use field DB (database) 106 in which use fields are stored; a detailed use field DB 107 in which detailed use fields are stored; a damage item DB 108 in which damage items are stored; a causal relationship DB 109 in which causal relationships are stored; and a solution descriptive text DB 110 in which descriptive texts of solutions are stored.

Further, as illustrated in FIG. 1, a user terminal 200 is connected to the input unit 101, and an external NW 300 is connected to the causal relationship DB 109.

Operations of each unit and examples of the specific contents of DBs will be described later. Note that the analysis/calculation unit 104 may also be called a calculation unit. Further, each of the DBs may be provided outside the assessment device 100.

The assessment device 100 can be implemented by having a computer execute a program in which the processing content described in the embodiment is written, for example.

That is, the assessment device 100 can be implemented by executing a program corresponding to the processing performed by the assessment device 100 by using hardware resources such as a CPU, a memory, and the like built in the computer. The program can be recorded on a computer readable recording medium (removable memory or the like) to be saved and distributed. Further, the program can also be provided via a network such as the Internet, e-mails, or the like.

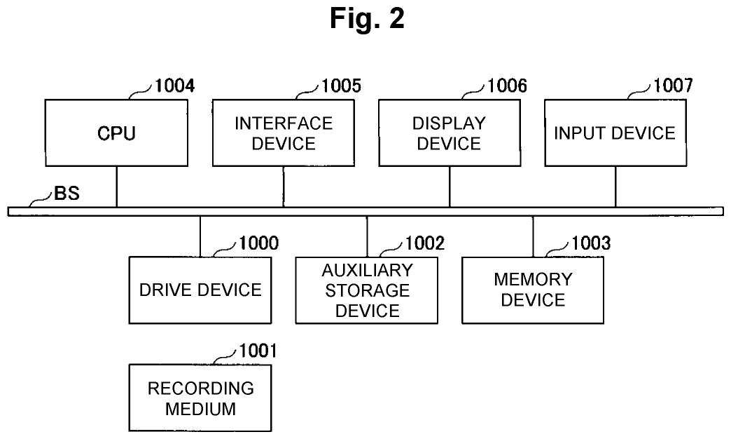

FIG. 2 is a diagram illustrating a hardware configuration example of the computer according to the embodiment. The computer illustrated in FIG. 2 includes a drive device 1000, an auxiliary storage device 1002, a memory device 1003, a CPU 1004, an interface device 1005, a display device 1006, an input device 1007, and the like connected mutually via a bus B.

The program implementing the processing by the computer is provided via a recording medium 1001 such as a CD-ROM or a memory card, for example. When the recording medium 1001 on which the program is recorded is set to the drive device 1000, the program is installed in the auxiliary storage device 1002 from the recording medium 1001 via the drive device 1000. Note, however, that the program is not necessarily installed via the recording medium 1001 but may be downloaded from another computer via the network. The auxiliary storage device 1002 stores the installed program and also stores necessary files, data, and the like.

When there is an instruction to start the program, the memory device 1003 reads the program from the auxiliary storage device 1002 and stores it. The CPU 1004 implements the function relates to the corresponding cache node 100 according to the program stored in the memory device 1003. The interface device 1005 is used as an interface for connecting to the network. The display device 1006 displays GUI (Graphical User Interface) and the like according to the program. The input device 1007 is configured with a keyboard and a mouse, a button, a touch panel, or the like, and used for inputting various operation instructions.

Note that the user terminal 200 illustrated in FIG. 1 may be a device configured with the display device 1006 and the input device 1007 illustrated in FIG. 2 or may be a computer connected to the interface device 1005 illustrated in FIG. 2 via a network.

(Operation Example)

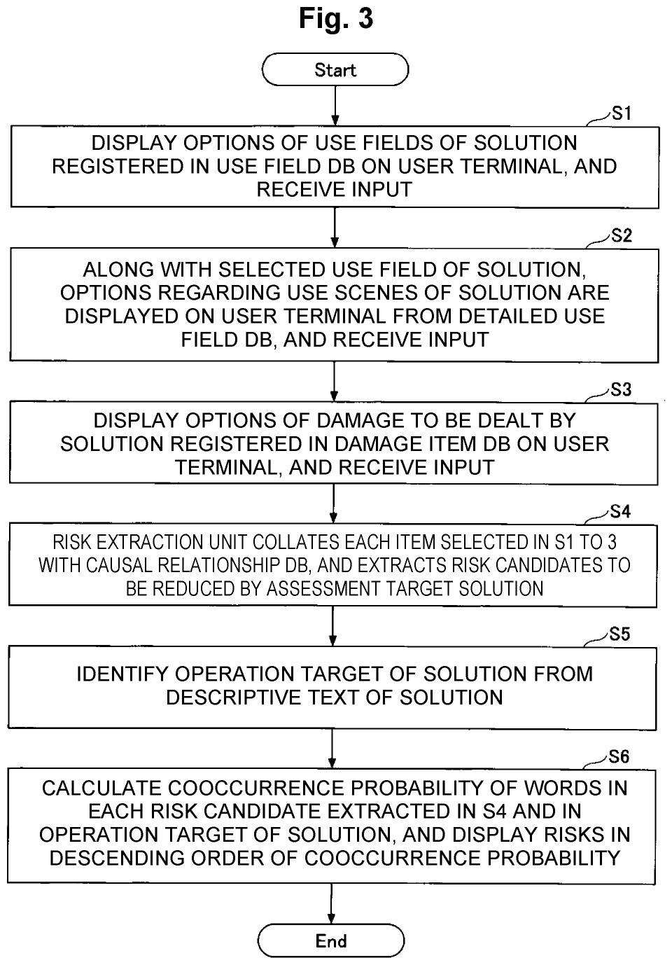

Next, an operation example of the assessment device 100 will be described along the procedure of the flowchart illustrated in FIG. 3. In each of the steps, the DBs referred in the corresponding steps are also described.

<Step 1>

In the use field DB 106, one or more use fields (examples: national life, natural environments, industries) of ICT solutions are stored. The input unit 101 reads the use fields from the use field DB 106, and transmits those to the user terminal 200. On the user terminal 200, a plurality of use fields are displayed as options.

A user selects the use field of the ICT solution as an assessment target on a screen of the user terminal 200. The selected use field is transmitted to the input unit 101 from the user terminal 200, and input to the assessment device 100 from the input unit 101. At this time, identification information (name or the like) of the ICT solution as the assessment target may be input to the assessment device 100 from the user terminal 200.

<Step 2>

In the detailed use field DB 107, one or more detailed use fields for each of the use fields (information regarding the use scenes of the ICT solutions) are stored. The use fields acquired in step 1 are given to the detailed use field DB 107 by the input processing unit 102, and the detailed use fields corresponding to the use fields acquired in step 1 are given to the input unit 101 from the detailed use field DB 107.

The input unit 101 transmits the detailed use fields to the user terminal 200. On the user terminal 200, one or more detailed use fields are displayed as options.

The user selects the detailed use field of the ICT solution as the assessment target on the screen of the user terminal 200. The selected detailed use field is transmitted to the input unit 101 from the user terminal 200, and input to the assessment device 100 from the input unit 101.

Note that it is also possible to display the options of the detailed use fields of step 2 for selecting the detailed use field without executing step 1.

Further, the use fields of step 1 and the detailed use fields of step 2 may collectively be called as “use fields”. Alternatively, the use fields of step 1 may be called as “higher-level use fields”, and the detailed use fields of step 2 may be called as “use fields”.

<Step 3>

In the damage item DB 108, one or more damage items (examples: heavy rain, flood, and the like) for which the ICT solution may possibly take measures are stored. The input unit 101 reads the damage items from the damage item DB 108, and transmits those to the user terminal 200. On the user terminal 200, one or more damage items are displayed as options.

The user selects the damage item addressed by the ICT solution as the assessment target on the screen of the user terminal 200. The selected damage item is transmitted to the input unit 101 from the user terminal 200, and input to the assessment device 100 from the input unit 101.

The information stored in the use field DB 106, the detailed use field DB 107, and the damage item DB 108 can be updated as appropriate. Further, the information input from the user terminal 200 in steps 1 to 3 is stored in a storage device such as the memory of the assessment device 100.

<Step 4>

In the causal relationship DB 109, as the causal relationships, the use fields, the detailed use fields, the damage items, and the risks are stored in an associated manner, for example. The causal relationships are built from texts such as the news acquired from the external NW 300 and a platform regarding climate change adaptation, and stored in advance in the causal relationship DB 109.

The risk extraction unit 103 collates each piece of the information selected by the user in steps 1 to 3 with the information stored in the causal relationship DB 109, and extracts the risk candidates that may possibly be reduced by the ICT solution in the use scene of the ICT solution as the assessment target.

<Step 5>

In the solution descriptive text DB 110, ICT solution descriptive texts are stored for each of the ICT solutions.

The analysis/calculation unit 104 reads the descriptive text of the ICT solution as the assessment target from the solution descriptive text DB, and identifies (extracts) an operation target of the ICT solution from the descriptive text by dependency parsing. For example, in a case of the ICT solution having a function of “monitoring electric power”, “electric power” is identified as the operation target.

<Step 6>

The analysis/calculation unit 104 calculates the word cooccurrence probability between each of the risk candidates extracted in step 4 and the operation target of the ICT solution extracted in step 5, and gives the risks to the output unit 105 in a descending order of cooccurrence probability. The output unit 105 transmits the risks to the user terminal 200. The user terminal 200 displays the risks in a descending order of cooccurrence probability. For example, the risk of highest cooccurrence probability is displayed at the top, and the risks thereafter are displayed toward the bottom in a descending order of cooccurrence probability.

The cooccurrence probability is generally used in the field of language processing, and it is an indicator for determining closeness of words in terms of the meanings. Note that it is possible to set in advance a threshold value of the cooccurrence probability, and not to output (that is, not to display) the risk candidate whose cooccurrence probability is less than the threshold value.

### SPECIFIC EXAMPLE

Next, a specific example of assessment executed by the assessment device 100 will be described. Here, described is an example when determining the risk caused by climate change that may possibly be reduced by a field management system. In the following explanation, step numbers in the flowchart illustrated in FIG. 3 are used as well.

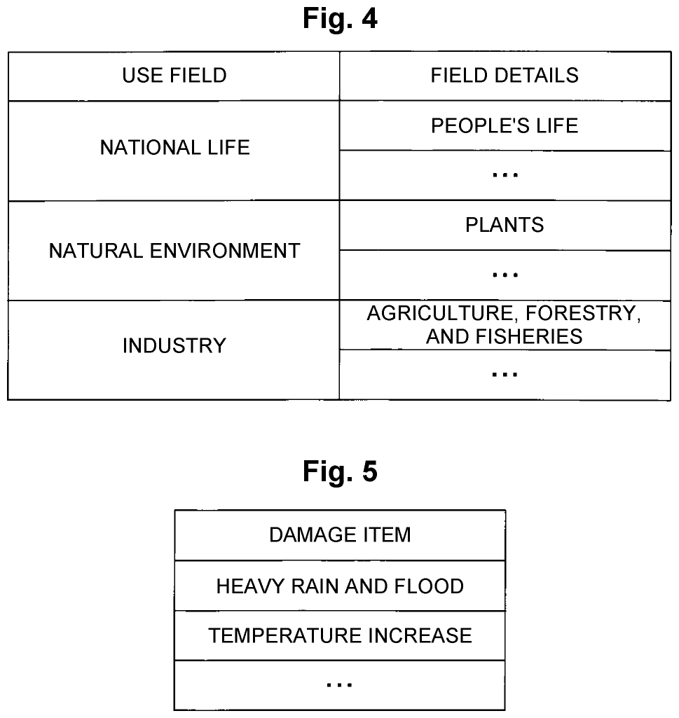

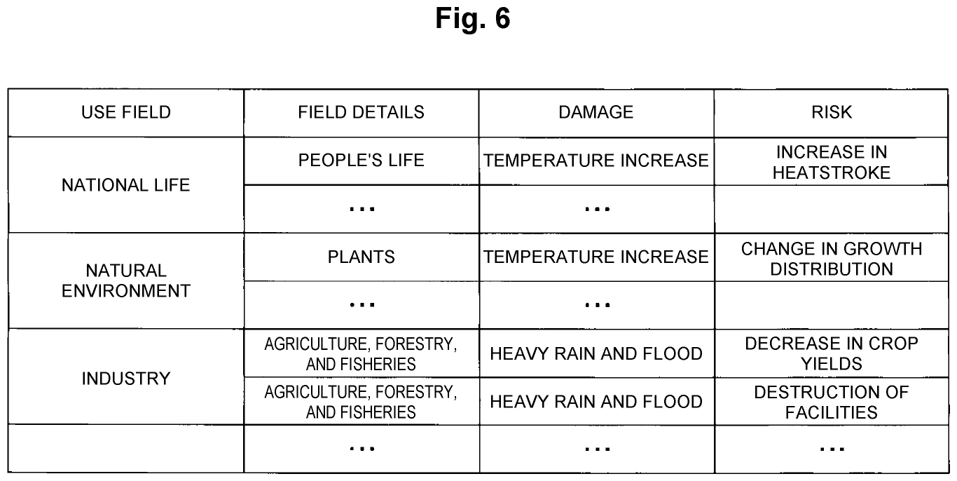

The field management system is an ICT solution that is used in agriculture to monitor the water temperature of a paddy field and improve efficiency of paddy rice cultivation. Examples of the use fields and the detailed use fields of the specific example are presented in FIG. 4. Further, examples of damage items of the specific example are presented in FIG. 5.

<Step 1, Step 2>

The options of the use fields of the ICT solution are displayed on the user terminal 200, and “industry” is selected. The selected “industry” is input to the assessment device 100 from the input unit 101. Then, options of the detailed use fields corresponding to the industry field are displayed on the user terminal 200, and “agriculture, forestry, and fisheries” is selected. The selected “agriculture, forestry, and fisheries” is input to the assessment device 100 from the input unit 101.

<Step 3>

On the user terminal 200, options of one or more damage items as the target of the ICT solution are displayed. Since the field management system of the specific example is designed to deal with heavy rain and flood, “heavy rain and flood” is selected. The selected “heavy rain and flood” is input to the assessment device 100 from the input unit 101.

<Step 4>

The risk extraction unit 103 collates each of the items selected in steps 1 to 3 with the information stored in the causal relationship DB 109 to extract the risk candidates.

Examples of the information stored in the causal relationship DB 109 in the specific example are presented in FIG. 6. In this case, the risk extraction unit 103 extract decrease in crop yields and destruction of facilities are extracted as the risk candidates caused by the damage of the heavy rain and flood damage in the agriculture, forestry, and fisheries in the industry field.

<Step 5>

The analysis/calculation unit 104 analyzes the descriptive text of the field management system by referring to the solution descriptive text DB 110, and identifies the operation target of the field management system as “water temperature”.

<Step 6>

The analysis/calculation unit 104 calculates the cooccurrence probability of “water temperature” and “crop yield” and the cooccurrence probability of “water temperature” and “facilities” as 0.7 and 0.1, respectively. The analysis/calculation unit 104 gives decrease in crop yields and destruction of facilities to the output unit 105, and the output unit 105 transmits those to the user terminal 200 to display those in a descending order of cooccurrence probability. On the user terminal 200, the risks that may possibly be reduced by the field management system are displayed in order from decrease in the crop yields to destruction of facilities.

(Effects of Embodiment)

According to the technique of the embodiment, it is possible to present, in order, the risk candidates that may possibly be reduced by the ICT solution as the assessment target. That is, it is possible to determine the risks of the climate change in the use scenes of the ICT solution. The determination result will be a material for determining whether or not the ICT solution contributes to climate change adaptation. Further, this determination can be easily done also by those who are not expert.

Furthermore, the determination result may be a material for a company to determine whether or not the own ICT solution can be applied to a climate change adaptation business and to consider whether or not to enter the business. Further, this makes it possible for the company to appeal the ICT solution in regards to climate change adaptation.

(Summary of Embodiment)

In the embodiment, at least the assessment device, the assessment method, and the program as follows are provided.

### (First Aspect)

An assessment device including:

an input unit that receives, as an input, a use field of an ICT solution as an assessment target and a damage item as a target of the ICT solution;

a risk extraction unit that extracts one or more risk candidates corresponding to the use field and the damage item from a database in which use fields, damage items, and risks are associated;

a calculation unit that calculates cooccurrence probability between each of the one or more risk candidates and an operation target of the ICT solution; and

an output unit that outputs the risk candidates based on the cooccurrence probability.

### (Second Aspect)

The assessment device according to the first aspect, wherein the use field is selected by a user from one or more use fields corresponding to a higher-level use field selected by the user.

### (Third Aspect)

The assessment device according to the first or second aspect, wherein the output unit outputs the risk candidates such that the risk candidates are displayed in a descending order of the calculated cooccurrence probability.

### (Fourth Aspect)

The assessment device according to any one of the first to third aspects, wherein the output unit outputs only the risk candidate whose calculated cooccurrence probability is equal to or higher than a threshold value.

### (Fifth Aspect)

The assessment device according to any one of the first to fourth aspects, wherein the calculation unit identifies the operation target from a descriptive text of the ICT solution.

### (Sixth Aspect)

An assessment method executed by an assessment device, the assessment method including:

an input step of inputting a use field of an ICT solution as an assessment target and a damage item as a target of the ICT solution;

a risk extraction step of extracting one or more risk candidates corresponding to the use field and the damage item from a database in which use fields, damage items, and risks are associated;

a calculation step of calculating cooccurrence probability between each of the one or more risk candidates and an operation target of the ICT solution; and

an output step of outputting the risk candidates based on the cooccurrence probability.

### (Seventh Aspect)

A program causing a computer to function as each of the units of the assessment device according to any one of the first to fifth aspects.

While the embodiment has been described above, the present invention is not limited to the specific embodiment but various modifications and changes are possible without departing from the scope of the gist of the present invention described in the appended claims.

### REFERENCE SIGNS LIST

100 Assessment device

101 Input unit

102 Input processing unit

103 Risk extraction unit

104 Analysis/calculation unit

105 Output unit

106 Use field DB

107 Detailed use field DB

108 Damage item DB

109 Causal relationship DB

110 Solution descriptive text DB

200 User terminal

300 External NW

1000 Drive device

1002 Auxiliary storage device

1003 Memory device

1004 CPU

1005 Interface device

1006 Display device

1007 Input device

1. An assessment device comprising:
an input unit, including one or more processors, configured to receive, as an input, a use field of an ICT solution as an assessment target and a damage item as a target of the ICT solution;
a risk extraction unit, including one or more processors, configured to extract one or more risk candidates corresponding to the use field and the damage item from a database in which use fields, damage items, and risks are associated;
a calculation unit, including one or more processors, configured to calculate cooccurrence probability between each of the one or more risk candidates and an operation target of the ICT solution; and
an output unit, including one or more processors, configured to the risk candidates based on the cooccurrence probability.

2. The assessment device according to claim 1, wherein the use field is selected by a user from one or more use fields corresponding to a higher-level use field selected by the user.

3. The assessment device according to claim 1, wherein the output unit is configured to output the risk candidates such that the risk candidates are displayed in a descending order of the calculated cooccurrence probability.

4. The assessment device according to claim 1, wherein the output unit is configured to output only the risk candidate whose calculated cooccurrence probability is equal to or higher than a threshold value.

5. The assessment device according to claim 1, wherein the calculation unit is configured to identify the operation target from a descriptive text of the ICT solution.

6. An assessment method executed by an assessment device, the assessment method comprising:
an input step of inputting a use field of an ICT solution as an assessment target and a damage item as a target of the ICT solution;
a risk extraction step of extracting one or more risk candidates corresponding to the use field and the damage item from a database in which use fields, damage items, and risks are associated;
a calculation step of calculating cooccurrence probability between each of the one or more risk candidates and an operation target of the ICT solution; and
an output step of outputting the risk candidates based on the cooccurrence probability.

7. A non-transitory computer readable medium storing a program causing a computer to function as an assessment device to perform an assessment method, comprising:
an input step of inputting a use field of an ICT solution as an assessment target and a damage item as a target of the ICT solution;
a risk extraction step of extracting one or more risk candidates corresponding to the use field and the damage item from a database in which use fields, damage items, and risks are associated;
a calculation step of calculating cooccurrence probability between each of the one or more risk candidates and an operation target of the ICT solution; and
an output step of outputting the risk candidates based on the cooccurrence probability.

8. The assessment device according to claim 6, wherein the use field is selected by a user from one or more use fields corresponding to a higher-level use field selected by the user.

9. The assessment device according to claim 6, further comprising:
outputting the risk candidates such that the risk candidates are displayed in a descending order of the calculated cooccurrence probability.

10. The assessment device according to claim 6, further comprising:
outputting only the risk candidate whose calculated cooccurrence probability is equal to or higher than a threshold value.

11. The assessment device according to claim 6, further comprising:
identifying the operation target from a descriptive text of the ICT solution.

12. The non-transitory computer readable medium according to claim 7, wherein the use field is selected by a user from one or more use fields corresponding to a higher-level use field selected by the user.

13. The non-transitory computer readable medium according to claim 7, wherein the stored program causes the computer to further perform:
outputting the risk candidates such that the risk candidates are displayed in a descending order of the calculated cooccurrence probability.

14. The non-transitory computer readable medium according to claim 7, wherein the stored program causes the computer to further perform:
outputting only the risk candidate whose calculated cooccurrence probability is equal to or higher than a threshold value.

15. The non-transitory computer readable medium according to claim 7, wherein the stored program causes the computer to further perform:
identifying the operation target from a descriptive text of the ICT solution.
